(19) United States
(12) Patent Application Publication
(10) Pub. No.: US 2025/0114881 A1
(43) Pub. Date: Apr. 10, 2025

(54) Jig Assembly for Electrode Tab and Welding Device for Electrode Tab Including the Same

(71) Applicant: LG Energy Solution, Ltd., Seoul (KR)

(72) Inventors: Min Cheol Park, Daejeon (KR); Jin Yong Lee, Daejeon (KR)

(73) Assignee: LG Energy Solution, Ltd., Seoul (KR)

(21) Appl. No.: 18/726,211

(22) PCT Filed: Feb. 9, 2023
(86) PCT No.: PCT/KR2023/001944

§ 371 Date: Jul. 2, 2024

(30) Foreign Application Priority Data
Feb. 15, 2022 (KR) 10-2022-0019800
Feb. 3, 2023 (KR) 10-2023-0014730

(51) Int. Cl. B23K 37/04; B23K 101/36; H01M 50/536

(52) U.S. Cl. CPC B23K 37/0443; H01M 50/536; B23K 2101/36

(57) ABSTRACT

The present invention relates to a jig assembly for an electrode tab, which includes: a first pressing member and a second pressing member, which are configured to press plurality of electrode tabs; and an adjustment jig configured to space the first pressing member and the second pressing member apart from each other to maintain an interval between the first pressing member and the second pressing member to adjust a pressing force applied to the electrode tabs.

### CROSS-REFERENCE TO RELATED APPLICATION

The present application is a national phase entry under 35 U.S.C. § International 371 of Application No. PCT/KR2023/001944 filed Feb. 9, 2023, which claims the benefit of the priority of Korean Patent Application Nos. 10-2022-0019800, filed on Feb. 15, 2022, and 10-2023-0014730, filed on Feb. 3, 2023, which are hereby incorporated by reference in their entirety.

### TECHNICAL FIELD

The present invention relates to a jig assembly for electrode tabs, which gathers the electrode tabs and a welding device for the electrode tabs, which includes the same.

### BACKGROUND ART

In general, secondary batteries refer to chargeable and dischargeable batteries, unlike primary batteries that are not chargeable. Secondary batteries are being widely used for mobile phones, notebook computers, and camcorders, electric vehicles, and the like.

Secondary batteries are classified into a can-type secondary battery, in which an electrode assembly is embedded in a metal can, and a pouch-type secondary battery in which an electrode assembly is embedded in a pouch. The can-type secondary battery includes assembly, a can accommodating the electrode assembly, and a cap assembly mounted on an opening of the can. In addition, the pouch-type secondary battery includes an electrode assembly, a pouch accommodating the electrode assembly, and an electrode lead connected to an electrode assembly and protruding out of the pouch.

Also, the electrode assembly has a structure in which a plurality of electrodes and a plurality of separators are alternately stacked, and the electrode tab is provided on an end of each of the electrodes. That is, the electrode tabs are provided at ends of the plurality of electrodes. In addition, the electrode tabs are coupled to an electrode lead in a bundled state.

The plurality of electrodes may be a positive electrode and a negative electrode. That is, the electrode assembly has a structure in which the positive electrode and the negative electrode are alternately disposed with a separator interposed therebetween.

Here, the electrode tabs and the electrode lead are coupled to each other through a welding device, and the welding device includes a guide jig that gathers the electrode tabs together, and a horn and anvil for welding the electrode tabs to the electrode lead. The guide jig includes first and second pressing members that press the upper and lower portions of the electrode tabs to gather the electrode tabs together.

However, the guide jig has a problem in that the electrode tabs may be damaged or deformed by a pressing force of the first and second pressing members.

### DISCLOSURE OF THE INVENTION

### Technical Problem

According to the present invention, pressing force applied to electrode tabs may be adjusted by spacing first and second pressing members apart from each other so as to be maintained at a predetermined distance or more, thereby preventing the electrode tabs from being damaged and deformed. Particularly, an object of the present invention is to provide a jig assembly for an electrode tab, in which an interval between first and second pressing members is easily adjusted to improve work efficiency, and a welding device for the electrode tab, which includes the same.

### Technical Solution

The present invention may relate to a jig assembly for an electrode tab, which includes: a first pressing member and a second pressing member, which are configured to press the electrode tab provided on a plurality of electrode parts so that the electrode tabs are gathered to be bundled; and an adjustment jig configured to space the first pressing member and the second pressing member apart from each other so that an interval between the first pressing member and the second pressing member is maintained at a set interval or more so as to adjust pressing force applied to the electrode tabs.

The adjustment jig may include an adjustment part provided between the first pressing member and the second pressing member to space the first pressing member and the second pressing member apart from each other so that the interval between the first pressing member and the second pressing member is maintained at the set interval or more.

The first pressing member and the second pressing member may be provided to extend to be elongated in a full-width direction of the electrode tabs, and the adjustment part may be provided between an end of the first pressing member and an end of the second pressing member, which extend to the outside of the electrode tabs.

A pressing surface of each of the first pressing member and the second pressing member, which press the electrode tabs, may be provided as a horizontal plane, and the adjustment part may have a square block shape to be in close surface contact with the pressing surface of each of the first pressing member and the second pressing member.

The set interval may be a thickness of the adjustment part, and the thickness of the adjustment part may be less than that of the bundled electrode tabs.

The adjustment jig may further include a fixing part provided on each of both ends of one surface of the adjustment part disposed in a full-length direction of the electrode tabs to support each of both surfaces of the first pressing member.

The fixing part and the adjustment part may be provided to be integrated with each other.

One fixing part of the fixing parts may be integrally provided on an end of one side of the adjustment part, and the other fixing part may be coupled to an end of the other side of the adjustment part so as to be slidably movable toward the first pressing member.

A guide groove extending toward the first pressing member may be defined in an end of one side of the adjustment part, and a guide protrusion slidably coupled to the guide groove may be disposed on the other fixing part.

The adjustment jig may further include a support part provided on one end of the other surface of the adjustment part disposed in a full-length direction of the electrode tabs so as to be supported on a surface of the second pressing member.

The support part and the adjustment part may be provided to be integrated with each other.

A protective film having elasticity may be further provided on a surface of the adjustment part on which the first pressing member and the second pressing member are supported.

Each of the first pressing member and the second pressing member may be made of a metal material, and one surface of the adjustment part may have magnetism to be attached to the first pressing member.

The jig assembly for the electrode tab may further include an inspection member configured to measure an interval between the first pressing member and the second pressing member, which are spaced apart from each other by the adjustment part, wherein, if the measured interval is within a range of an input set interval, it may be determined as being normal, and if the measured interval is out of the range of the set interval, it may be determined as being defective.

A welding device for an electrode tab according to the present invention may include the jig assembly for the electrode tab.

### Advantageous Effects

The jig assembly for the electrode tab according to the present invention may include the adjustment jig so that the interval between the first and second pressing members are spaced apart from each other so as to be maintained at the set distance or more from, and thus, the pressing force applied to the electrode tabs may be adjusted to prevent the electrode tabs from being damaged and deformed. Particularly, since the interval between the first and second pressing members may be easily adjusted to improve the work efficiency.

### BRIEF DESCRIPTION OF THE DRAWINGS

FIG. 1 is an exploded perspective view illustrating a jig assembly for an electrode tab according to a first embodiment of the present invention.

FIG. 2 is an assembled perspective view illustrating the jig assembly for the electrode tab according to the first embodiment of the present invention.

FIG. 3 is a front view of the jig assembly of FIG. 2.

FIG. 4 is a side view of the jig assembly of FIG. 2.

FIG. 5 is a side view illustrating a welding device for an electrode tab according to a second embodiment of the present invention.

FIG. 6 is a perspective view illustrating a jig assembly for an electrode tab according to a third embodiment of the present invention.

FIG. 7 is a side view illustrating a welding device for an electrode tab according to a fourth embodiment of the present invention.

FIG. 8 is a side view illustrating a welding device for an electrode tab according to a fifth embodiment of the present invention.

### MODE FOR CARRYING OUT THE INVENTION

Hereinafter, embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein. In the drawings, anything unnecessary for describing the present invention will be omitted for clarity, and also like reference numerals in the drawings denote like elements.

### [Secondary Battery]

A secondary battery includes an electrode assembly and a pouch accommodating the electrode assembly. The electrode assembly has a structure in which a plurality of electrodes and a plurality of separators are alternately disposed. In addition, the pouch includes an accommodation part accommodating the electrode assembly and a sealing part sealing the accommodation part.

The plurality of electrodes may be positive and negative electrodes. That is, the electrode assembly has a structure in which the positive electrode and the negative electrode are alternately disposed with a separator interposed therebetween.

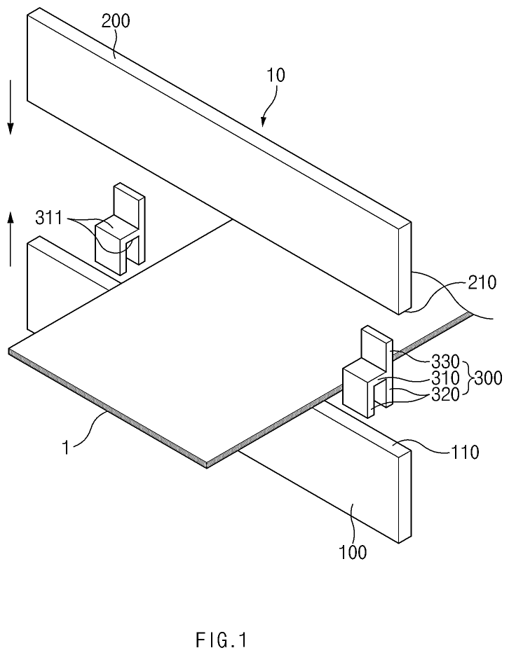

Referring to FIG. 1, an electrode tab is provided on an end of the electrode. That is, a plurality of electrode tabs 1 (hereinafter, referred to as electrode tabs) are provided on ends of the plurality of electrodes. In addition, the electrode leads 2 are coupled to the electrode tabs 1.

Here, in order to couple the electrode tabs to the electrode lead 2, the electrode tabs 1 have to be gathered together, and at this time, the jig assembly 10 for the electrode tabs according to the first embodiment of the present invention is used.

### [Jig Assembly for Electrode Tab According to First Embodiment of the Present Invention]

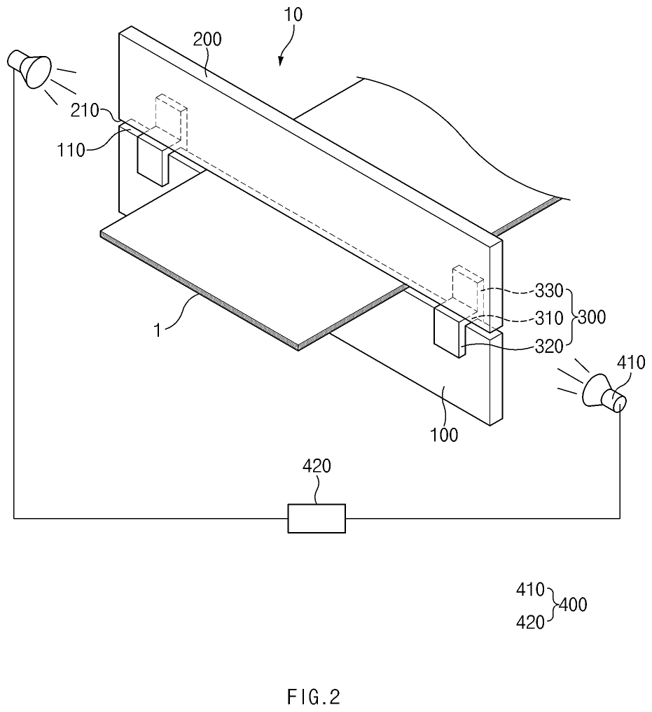

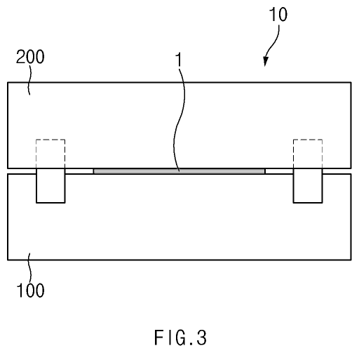

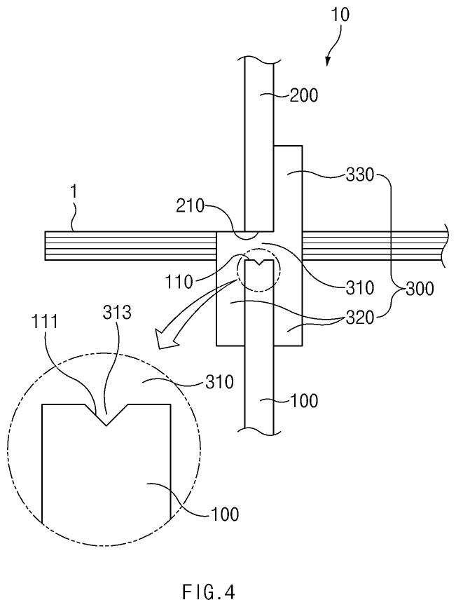

FIG. 1 is an exploded perspective view illustrating a jig assembly for an electrode tab according to a first embodiment of the present invention, FIG. 2 is an assembled perspective view illustrating the jig assembly for the electrode tab according to the first embodiment of the present invention, FIG. 3 is a front view of FIG. 2, and FIG. 4 is a side view of FIG. 2.

As illustrated in FIGS. 1 to 4, a jig assembly 10 for electrode tabs according to a first embodiment of the present invention is configured to gather electrode tabs 1 provided on ends of a plurality of electrodes.

That is, the jig assembly 10 for the electrode tabs according to the first embodiment of the present invention includes a first pressing member 100, a second pressing member 200, and an adjustment jig 300.

### First Pressing Member and Second Pressing Member

The first pressing member 100 and the second pressing member 200 press the electrode tabs 1 to gather the electrode tabs 1 together. That is, referring to FIG. 1, the first pressing member 100 and the second pressing member 200 have a structure, in which the first pressing member 100 and the second pressing member 200 are symmetrically provided on the uppermost and lowermost ends of the electrode tabs 1, respectively, and press the electrode tabs 1 so that the electrode tabs 1 are bundled to be gathered.

For example, the first pressing member 100 is disposed on the lowermost end of the electrode tabs 1, and the second pressing member 200 is disposed to be movable toward the first pressing member 100 by a hydraulic device (not shown) in a state of being disposed at the uppermost end of the electrode tabs 1. Thus, the electrode tabs 1 are gathered or brought together by the first and second pressing members 100 and 200.

Each of a pressing surface 110 of the first pressing member 100 and a pressing surface 210 of the second pressing member 200, which press the electrode tabs 1, may be provided as a horizontal plane to increase in adhesion.

### Adjustment Jig

The adjustment jig 300 spaces the first pressing member 100 and the second pressing member 200 apart from each other so that the first pressing member 100 and the second pressing member 200 are maintained at a set interval or more, thereby adjusting pressing force applied to the electrode tabs 1. In other words, the adjustment jig may space the first pressing member 100 and the second pressing member 200 so that the first pressing member 100 and the second pressing member 200 are not spaced less than a set interval from each other.

For example, the adjustment jig 300 includes an adjustment part 310. The adjustment part 310 is provided between the first pressing member 100 and the second pressing member 200 to support the first pressing member 100 and the second pressing member 200.

That is, the adjustment part 310 may be disposed between the pressing surface 110 of the first pressing member 100 and the pressing surface 210 of the second pressing member 200, and thus, the first pressing member 100 and the second pressing member 200 may be maintained to be spaced a set interval or more from each other. In other words, the adjustment part 310 may space the first pressing member 100 and the second pressing member 200 apart from each other so that the first pressing member 100 and the second pressing member 200 are maintained at a set distance or more, and thus, the electrode tabs pressed by the first pressing member 100 and the second pressing member 200 may be adjusted so as not to be pressed by tabs spaced less than the set interval from each other, thereby preventing the electrode tabs 1 from being damaged and deformed.

The first pressing member 100 and the second pressing member 200 may be provided to be elongated in a full-width direction of the electrode tabs 1 (left and right direction when viewed in FIG. 3). In addition, the adjustment part 310 may be provided between an end of the first pressing member 100 and an end of the second pressing member 200, which extend to the outside of the electrode tabs 1. Thus, it is possible to prevent an interference between the adjustment part 310 and the electrode tabs 1, and as a result, it is possible to prevent an electrode tab part from being damaged by the adjustment part 310. Particularly, the adjustment part 310 may be provided between both lateral ends of the first pressing member 100 and both lateral ends of the second pressing member 200, and thus, the first pressing member 100 and the second pressing member 200 may be stably supported.

The adjustment part 310 may have a square block shape so that the pressing surfaces 210 of the first pressing member 100 and the second pressing member 200 are in close surface contact with each other. Particularly, the adjustment part 310 may be made of the same material as that of each of the first pressing member 100 and the second pressing member 200. Thus, it is possible to prevent the adjustment part 310 or the first pressing member 100 and the second pressing member 200 from being easily worn out.

An adhesive layer may be further provided between the adjustment part and the first pressing member. Thus, adhesion between the adjustment part and the first pressing member may increase. Referring to the enlarged view of FIG. 4, a ‘V’-shaped coupling groove 111 may be defined in the pressing surface 110 of the first pressing member 100 in a longitudinal direction, and a ‘V’-shaped coupling protrusion 313 may be defined in the adjustment part 310 so as to be disposed within and movable along the coupling groove 111 in the lateral direction. This may prevent fixing force and shaking of the adjustment part.

The set interval may be a thickness of the adjustment part 310. In addition, the thickness of the adjustment part 310 may be equal to or less than a thickness of the bundled electrode tabs 1. Preferably, the thickness of the adjustment part is less than the thickness of the bundled electrode tabs. Thus, the electrode tabs 1 may be effectively pressed by the first pressing member 100 and the second pressing member 200, and thus, the electrode tabs 1 may be gathered to be bundled.

The adjustment jig 300 may further include a fixing part 320. The fixing part 320 may be provided on each of both ends (both ends of a bottom surface of the adjustment part 310 when viewed in FIG. 1) of one surface of the adjustment part 310 disposed in a full-length direction of the electrode tabs 1 (i.e., the lengthwise direction of the electrode tabs) such that the fixing part 320 straddles the first pressing member 100 and may be supported on both surfaces of the first pressing member 100. Thus, the adjustment part 310 may be disposed so as not to move on the pressing surface 110 of the first pressing member 100.

The fixing part 320 and the adjustment part 310 may be integrally provided. That is, the fixing part 320 and the adjustment part 310, which are integrated with each other, may have a “ [symbol] ” shape. Thus, ease of the manufacture may be improved.

The adjustment jig 300 may further include a support part 330. The support part 330 is provided on one end of the other surface of the adjustment part 310 (rear end of a top surface of the adjustment part 310 when viewed in FIG. 1) disposed in the full-length direction of the electrode tabs 1 and is supported on the second pressing member 200. That is, the support part 330 guides the second pressing member 200 to be supported on the top surface of the adjustment part 310.

The support part 330 and the adjustment part 310 may be integrally provided. Thus, ease of the manufacture may be improved.

Therefore, the jig assembly 10 for the electrode tabs according to the first embodiment of the present invention may adjust the pressing force applied to the electrode tabs 1 by providing the adjustment jig 300, and as a result, the electrode tabs 1 may be prevented from being damaged and deformed. Particularly, since the interval between the first and second pressing members 200 may be easily adjusted to improve the work efficiency.

The jig assembly 10 for an electrode tab according to the first embodiment of the present invention may further include an inspection member 400.

### Inspection Member

Referring to FIG. 2, the inspection member 400 is configured to measure the interval or gap between the first pressing member 100 and the second pressing member 200. That is, the inspection member 400 measures the interval between the first pressure member 100 and the second pressure member 200, which are spaced apart from each other by the adjustment part 310, and if the measured interval is within a range of an input set interval, it is determined as being normal, and if the measured interval is out of the range of the set interval, it is determined as being defective.

The inspection member 400 includes an infrared camera 410 that measures the interval between the first pressing member 100 and the second pressing member 200 and an inspection part 420 that measures the interval between the first pressing member 100 and the second pressing member 200 through an image photographed by the infrared camera 410 to inspect whether the measured interval is within the range of the input set interval.

Therefore, the jig assembly 10 for the electrode tab according to the first embodiment of the present invention may further include the inspection member 400 to easily check whether the interval between the first pressing member 100 and the second pressing member 200 is reduced below the set interval or above the set interval.

Hereinafter, in describing another embodiment of the present invention, the same reference numerals are used for the same components as those of the above-described embodiment, and duplicated descriptions will be omitted.

### [Welding Device for Electrode Tab According to Second Embodiment of the Present Invention]

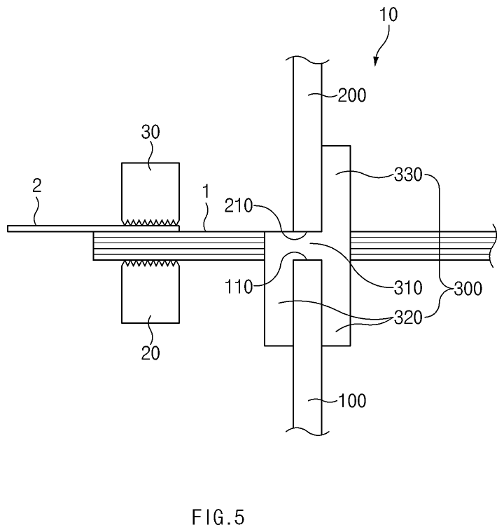

FIG. 5 is a side view illustrating a welding device for an electrode tab according to a second embodiment of the present invention.

A welding device for an electrode tab according to a second embodiment of the present invention has a structure including a jig assembly for an electrode tab that is described above.

For example, as illustrated in FIG. 5, the welding device for the electrode tab according to the second embodiment of the present invention includes a jig assembly for the electrode tab that presses electrode tabs 1 provided on opposing ends of a plurality of electrodes to gather (e.g., bring together) the electrode tabs 1, an anvil 20 supporting a bottom surface of a welding part in which the electrode tabs and an electrode lead 2 overlap each other, and a horn 30 disposed on a top surface of the welding part to weld the electrode tabs 1 to the electrode lead 2 using ultrasonic waves in a state of pressing the electrode tab 1 together with the anvil 20.

The jig assembly for the electrode tab has the same configuration as the jig assembly for the electrode tab described in the first embodiment, and thus, duplicated descriptions are omitted.

Therefore, the welding device for electrode tab according to the second embodiment of the present invention may stably weld the electrode tabs to the electrode lead 2 without damaging or deforming the electrode tabs 1.

### [Jig Assembly for Electrode Tab According to Third Embodiment of the Present Invention]

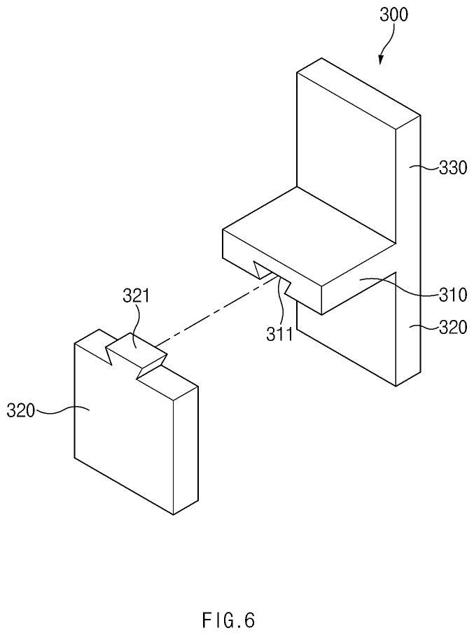

FIG. 6 is a perspective view illustrating a jig assembly for an electrode tab according to a third embodiment of the present invention.

A jig assembly for an electrode tab according to a third embodiment of the present invention includes an adjustment jig 300, and the adjustment jig 300 includes a fixing part 320 provided on each of both ends of a bottom surface of the adjustment part 310.

Here, one fixing part 320 of the fixing parts 320 is integrally provided on one end of an adjustment part 310, and the other fixing part 320 is coupled to the other end of the adjustment part 310. Here, the other fixing part 320 is coupled to be slidably movable toward the first pressing member 100.

For example, a guide groove 311 extending toward the first pressing member 100 is defined in one end of the adjustment part 310, and a guide protrusion 321 slidably coupled to the guide groove 311 is disposed on the other fixing part 320. Thus, an interval between the fixing part 320 provided on each of both the ends of the adjustment part 310 and the fixing part 320 may be adjusted. The fixing part that is fixed in position may be fixed to the adjustment part through a fixing means such as a bolt.

Therefore, the jig assembly for the electrode tab according to the third embodiment of the present invention may be used to be compatible with the first pressing member 100 having various thicknesses. Particularly, the adjustment jig may be compressed to the first pressing member 100 by adjusting the interval between the fixing part 320 and the fixing part 320 to prevent the adjustment jig 300 from being separated from the first pressing member 100.

### [Jig Assembly for Electrode Tab According to Fourth Embodiment of the Present Invention]

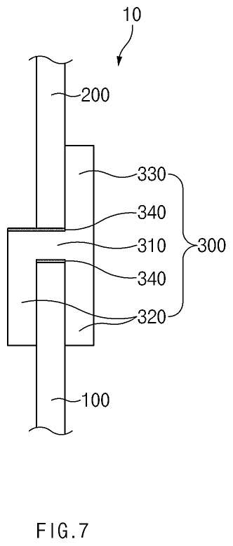

FIG. 7 is a side view illustrating a welding device for an electrode tab according to a fourth embodiment of the present invention.

As illustrated in FIG. 7, a jig assembly for an electrode tab according to a fourth embodiment of the present invention includes an adjustment part 310 supporting a first pressing member 100 and a second pressing member 200.

Here, a protective film having elasticity is provided on a surface of the adjustment part 310 on which the first pressing member 100 and the second pressing member 200 are supported. The protective film may be made of a synthetic resin material.

Therefore, a welding device for the electrode tab according to the fourth embodiment of the present invention may prevent impact force and noise between the first pressing member 100 and the adjustment part 310 or between the second pressing member 200 and the adjustment part 310 from occurring, and particularly, may significantly prevent abrasion from occurring.

The protective film may have a thickness of 1 μm to 10 μm and may be replaced every set time.

### [Jig Assembly for Electrode Tab According to Fifth Embodiment of the Present Invention]

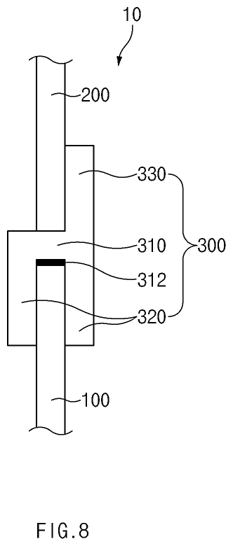

FIG. 8 is a side view illustrating a welding device for an electrode tab according to a fifth embodiment of the present invention.

As illustrated in FIG. 8, in a jig assembly for an electrode tab according to a fifth embodiment of the present invention, each of a first pressing member 100 and a second pressing member 200 is made of a metal material, and one surface of an adjustment part 310 (bottom surface of the adjustment part 310 when viewed in FIG. 8) has magnetic force to be attached to the first pressing member 100. That is, one surface of the adjustment part 310 may be provided as a magnet surface 312.

Therefore, in the welding device for the electrode tab according to the fifth embodiment of the present invention, the adjustment part 310 may be stably attached and fixed to the first pressing member 100 without a separate member.

Accordingly, the scope of the present invention is defined by the appended claims more than the foregoing description and the exemplary embodiments described therein. Various modifications made within the meaning of an equivalent of the claims of the invention and within the claims are to be regarded to be in the scope of the present invention.

### DESCRIPTION OF THE SYMBOLS

1: Electrode tab
2: Electrode lead
10: Jig assembly for electrode tab
20: Anvil
30: Horn
100: First pressing member
110: Pressing surface
111: Coupling groove
200: Second pressing member
210: Pressing surface
300: Adjustment jig
310: Adjustment part
311: Guide groove
312: Magnet surface
313: Coupling protrusion
320: Fixing part
321: Guide protrusion
330: Support part
400: Inspection member

1. A jig assembly for an electrode tab, comprising:
a first pressing member and a second pressing member, which are configured to press a plurality of electrode tabs; and
an adjustment jig configured to space the first pressing member and the second pressing member apart from each other to maintain an interval between the first pressing member and the second pressing member to adjust a pressing force applied to the electrode tabs.

2. The jig assembly for the electrode tab of claim 1, wherein the adjustment jig comprises an adjustment part provided between the first pressing member and the second pressing member to space the first pressing member and the second pressing member apart from each other so that the interval between the first pressing member and the second pressing member is maintained at a set interval or more.

3. The jig assembly for the electrode tab of claim 2, wherein the first pressing member and the second pressing member extend in a width direction of the electrode tabs, and
the adjustment part is provided between an end of the first pressing member and an end of the second pressing member, which are positioned to surround the electrode tabs.

4. The jig assembly for the electrode tab of claim 2, wherein a pressing surface of each of the first pressing member and the second pressing member, which press the electrode tabs, is planar, and
the adjustment part has a square block shape and contacts the pressing surface of each of the first pressing member and the second pressing member.

5. The jig assembly for the electrode tab of claim 2, wherein the set interval is a thickness of the adjustment part, and
the thickness of the adjustment part is less than that of the bundled electrode tabs.

6. The jig assembly for the electrode tab of claim 2, wherein the adjustment jig further comprises a pair of fixing parts provided on each of a pair of opposing ends of a surface of the adjustment part disposed in a full-length direction of the electrode tabs to support each of a pair of opposing surfaces of the first pressing member.

7. The jig assembly for the electrode tab of claim 6, wherein the fixing part and the adjustment part are integral.

8. The jig assembly for the electrode tab of claim 6, wherein a first fixing part of the pair of fixing parts is integrally provided on an end of one side of the adjustment part, and a second fixing part of the pair of fixing parts is coupled to an end of an opposing side of the adjustment part so as to be slidably movable toward the first pressing member.

9. The jig assembly for the electrode tab of claim 8, wherein a guide groove extending toward the first pressing member is defined in an end of one side of the adjustment part, and
a guide protrusion slidably coupled to the guide groove is disposed on the second fixing part.

10. The jig assembly for the electrode tab of claim 2, wherein the adjustment jig further comprises a support part provided on one end of a surface of the adjustment part disposed in a length direction of the electrode tabs so as to extend adjacent a surface of the second pressing member.

11. The jig assembly for the electrode tab of claim 10, wherein the support part and the adjustment part are integral.

12. The jig assembly for the electrode tab of claim 2, further comprising a protective film having elasticity further provided on a surface of the adjustment part on which the first pressing member and the second pressing member contact.

13. The jig assembly for the electrode tab of claim 2, wherein each of the first pressing member and the second pressing member is made of a metal material, and
one surface of the adjustment part has magnetism to be attached to the first pressing member.

14. The jig assembly for the electrode tab of claim 2, wherein the jig assembly for the electrode tab further comprises an inspection member configured to measure the interval between the first pressing member and the second pressing member, which are spaced apart from each other by the adjustment part,
wherein, if the measured interval is within a range of an input set interval, it is determined as being normal, and if the measured interval is outside of the range of the set interval, it is determined as being defective.

15. A welding device for an electrode tab, comprising the jig assembly for the electrode tab of claim 1.
